(19) United States
(12) Patent Application Publication
(10) Pub. No.: US 2016/0029098 A1
(43) Pub. Date: Jan. 28, 2016

(54) METHOD AND APPARATUS FOR PROVIDING MEDIA ASSET RECOMMENDATIONS

(71) Applicants: Joel FOGELSON, (US); Michael ETTER, (US); Greg Alan MARTIN, (US); Noah DIJULIO, (US); Ryan Cameron COULTER, Portland, OR (US); Laura J. O'DONNELL, (US); THOMSON LICENSING, Issy les Moulineaux (FR)

(72) Inventors: Joel FOGELSON, Pasadena, CA (US); Michael ETTER, Portland, OR (US); Greg Alan MARTIN, Portland, OR (US); Noah DIJULIO, Portland, OR (US); Ryan Cameron COULTER, Portland, OR (US); Laura J. O'DONNELL, Los Angeles, CA (US)

(21) Appl. No.: 14/771,824

(22) PCT Filed: Mar. 14, 2013
(86) PCT No.: PCT/US2013/031437

§ 371 Date: Sep. 1, 2015

(51) Int. Cl. H04N 21/482; H04N 21/431; H04N 21/25

(52) U.S. Cl. CPC H04N 21/4826; H04N 21/252; H04N 21/431

(57) ABSTRACT

A method for generating recommendations for a group of users is disclosed. The method includes providing a display of a plurality of user representations respectively representing users; receiving a selection of at least two of the user representations to form a group; providing a display of at least one recommendation for a media asset after the group has been formed; and providing a display of an indicator indicating that a user representation in the group is selected as an allowed user representation in the group for selecting one of the at least one recommendation for receipt by user devices respectively associated with the user representations in the group.

### FIELD OF THE INVENTION

The present disclosure generally relates to media asset recommendations, and more specifically to generating media asset recommendations for a group of users using corresponding user profile information, and automatically selecting a user in a group to select one of the recommendations for receipt by user devices associated with the users in the group.

### BACKGROUND OF THE INVENTION

When a user is interested in watching a movie or a television show, as a form of a media asset, the user may want to receive recommendations about media assets that the user does not know anything about. Some systems provide a user with recommendations that are based on user profile information associated with the user based on the person's prior consumption of such assets. A difficultly can arise if the user wants to consume a media asset with a second person, at the same time, where the prior systems typically accommodate media asset suggestions for only one person. Hence, the suggestions for media assets would only pertain to the user or the second person, but not both.

### SUMMARY OF THE INVENTION

In accordance with an aspect of the present invention, a method for selecting recommendations is disclosed. The method comprises steps of providing a display of a plurality of user representations respectively representing users; receiving selection of at least two of said user representations to form a group in response to a user input; providing a display of at least one recommendation for a media asset after the group has been formed; and providing a display of an indicator indicating that a user representation in the group is selected as an allowed user representation in the group for selecting one of the at least one recommendation for receipt by user devices respectively associated with the user representations in said group.

In one embodiment, the at least one recommendation is available for display in the user devices associated with the user representations in the group.

In another embodiment, the method may further comprise a step of after the selected allowed user representation in the group has made a selection, providing a display of the indicator indicating another user representation in the group is selected as the allowed user representation.

In yet another embodiment, a first set of the at least one recommendation falling in a first time interval are displayed according to start time, wherein start times of the first set are within said first time interval and the method further comprises replacing the first set with a second set in the at least one recommendation in display responsive to detecting rotation movement around the group in one direction, wherein a second time interval is later than the first time interval and the second set in the at least one recommendation having start times within the second time interval; and replacing the first set with a third set in the at least one recommendation in display responsive to detecting rotation movement around the group in the other direction, wherein a third time interval is earlier than the first time interval and the third set in the at least one recommendation having start time within the third time interval.

In yet another embodiment, the selected recommendation is placed in a queue by a server and the server delivers the selected recommendation when a start time of the selected one of the at least one selected recommendation has arrived.

In accordance with another aspect of the present invention, a user device for selecting recommendations is disclosed. The user device comprises a video processor interfacing with a display device; and a controller enabling the video processor to produce display signals, wherein the controller is operative to enable display of a plurality of user representations respectively representing users, selection of at least two of the user representations to form a group, display of at least one recommendation for a media asset after the group has been formed; and display of an indicator indicating that a user representation in the group is selected as an allowed user representation in the group for selecting one of the at least one recommendation for receipt by user devices respectively associated with the user representations in the group.

In one embodiment, after the selected allowed user representation in the group has made a selection, the controller is operative to enable display of the indicator indicating another user representation in the group is selected as the allowed user representation.

In another embodiment, the controller is operative to enable display of a first set of the at least one recommendation falling in a first time interval according to start time wherein start times of the first set are within said first time interval.

In yet another embodiment, the controller is operative to replace the first set with a second set in the at least one recommendation in display responsive to detecting rotation movement around said group in one direction, wherein a second time interval is later than the first time interval and the second set in the at least one recommendation having start times within the second time interval; and replaces the first set with a third set in the at least one recommendation in display responsive to detecting rotation movement around the group in the other direction, wherein a third time interval is earlier than the first time interval and the third set in the at least one recommendation having start time within the third time interval.

In accordance with another aspect of the present invention, a user device for selecting recommendations is disclosed. The user device comprises means for interfacing with a display device; and means for enabling the video processor to produce display signals, wherein the enabling means is operative to enable display of a plurality of user representations respectively representing users, selection of at least two of the user representations to form a group, display of at least one recommendation for a media asset after the group has been formed; and display of an indicator indicating that a user representation in the group is selected as an allowed user representation in the group for selecting one of the at least one recommendation for receipt by user devices respectively associated with the user representations in the group.

In one embodiment, after the selected allowed user representation in the group has made a selection, the enabling means is operative to enable display of the indicator indicating another user representation in the group is selected as the allowed user representation.

In another embodiment, the enabling means is operative to enable display of a first set of the at least one recommendation falling in a first time interval according to start time wherein start times of the first set are within said first time interval.

In yet another embodiment, the enabling means is operative to replace the first set with a second set in the at least one recommendation in display responsive to detecting rotation movement around said group in one direction, wherein a second time interval is later than the first time interval and the second set in the at least one recommendation having start times within the second time interval; and replaces the first set with a third set in the at least one recommendation in display responsive to detecting rotation movement around the group in the other direction, wherein a third time interval is earlier than the first time interval and the third set in the at least one recommendation having start time within the third time interval.

In another embodiment, the selected allowable user representation is prevented from being selected again until all other user representations in the group have been selected as the allowed user representation.

In accordance with another aspect of the present invention, a method for providing recommendations for a group is disclosed. The method comprises receiving forming of the group of at least two user representations respectively representing users; providing at least one recommendation according to profiles of the at least two user representations; and selecting a first one of the at least two user representations in the group as an allowed user representation in the group for selecting one of the at least one recommendation for receipt by user devices respectively associated with the user representations in the group.

In one embodiment, the method further includes the step of after the selected allowed user representation in the group has made a selection, selecting another user representation in the group as the allowed user representation.

In another embodiment, the selected allowable user representation is prevented from being selected again until all other user representations in the group have been selected as said allowed user representation.

In another embodiment, a user representation is selected as the allowed user representation in one of random and round robin manners.

### DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system communicating media assets in accordance with an embodiment of the present disclosure;

FIG. 2 is a block diagram of an exemplary consumption device in accordance with an embodiment of the present disclosure;

FIG. 3 is a user interface that is used for generating media asset recommendations in accordance with an embodiment of the present disclosure;

FIG. 4 is a user interface that is used for generating media asset recommendations in accordance with an embodiment of the present disclosure;

FIG. 5 is a user interface that is used for generating media asset recommendations in accordance with an embodiment of the present disclosure;

FIG. 6 is a user interface that is used for generating media asset recommendations in accordance with an embodiment of the present disclosure;

FIG. 7 is a user interface that is used for generating media asset recommendations in accordance with an embodiment of the present disclosure;

FIG. 8 is a user interface that is used for generating media asset recommendations in accordance with an embodiment of the present disclosure;

FIG. 9 displays a flow diagram of a method for generating media asset recommendations in response to the manipulation of a user interface in accordance with an embodiment of the present disclosure;

FIG. 10 illustrates an exemplary process flow for enabling automatic selection of each user representation in a group to select a recommendation displayed in the result zone 380 for receipt by user devices associated with the user representations in the group;

FIG. 11 illustrates an indicator in an user interface indicating which one of the user representations in a group is allowed to select one of the recommendations for receipt by user devices associated with user representations in the group;

FIG. 12 illustrates that the user initiates a clockwise rotation action on the user interface 1200;

FIG. 13 illustrates an exemplary user interface 1300 where the time interval has been advanced as a result of the clockwise rotation action in the user interface 1200 shown in FIG. 12 being detected by the user device; and

FIG. 14 illustrates an exemplary process flow 1400 for automatic selection of a user representation in a group for selecting one of the at least one recommendation for receipt by user devices respectively associated with the user representations in the group.

### DESCRIPTION OF THE PREFERRED EMBODIMENTS

For purposes of this specification, the term social publishing service is an internet based service where a user posts different types of media assets such as videos, audio, pictures, electronic messages, links to websites, a message text, and the like to the publishing service. These media assets are then provided to a user who is accessing the social publishing. Some social publishing services support the publishing of multiple types of media assets as well. External users can access these published media assets through a program such as a web browser, a client application written specifically for a social publishing service which access such a social publishing service directly. Examples of existing social publishing services include FACEBOOK, TWITTER, FLICKR, PINTREST, INSTAGRAM, TUMBLR, YOUTUBE, and the like.

Social publishing services can also receive media assets from other social publishing services. For example, a user can publish their photos from a first social publishing service to a second publishing service. The same user can also publish other types of media assets from other publishing services to the second publishing service. In addition, some publishing services are capable of having media assets reposted from other users. For example, a first user can publish a media asset received from a second user through a social publishing service where such an operation is called a reposting operation.

Media assets from a social publishing service can also be forwarded to a user where such media assets can be collected in a storage repository such as a digital locker implemented as a server.

The term specified party relates to a person or service that a user permissively agrees to receive media assets from. In one example, a user accepts an invitation from a specified party on a social networking service such as FACEBOOK where the social networking service will make available through a posting operation, forwarding operation, communicating operation, providing operation, and the like, media assets from the specified party to the user. Conversely, a user sends an invitation to the specified party on a social networking service, where the media assets published by the specified party will be forwarded to the user when the specified party accepts the invitation. In a second example, a user indicates through a social publishing service such as TWITTER that the user wants to follow the posts from a specified party. Other connections between a user and a specified party can be created in accordance with the disclosed principles.

Users can be known as being linked or connected when a first user and a second user are “FRIENDS” of each other through a social networking service, where the first and second users are listed on the same list of a third user, a first and second user are grouped together in the same category either implicitly or explicitly with each other's permission, a first and second user are grouped together in the same category either implicitly or explicitly by a third party, and the like.

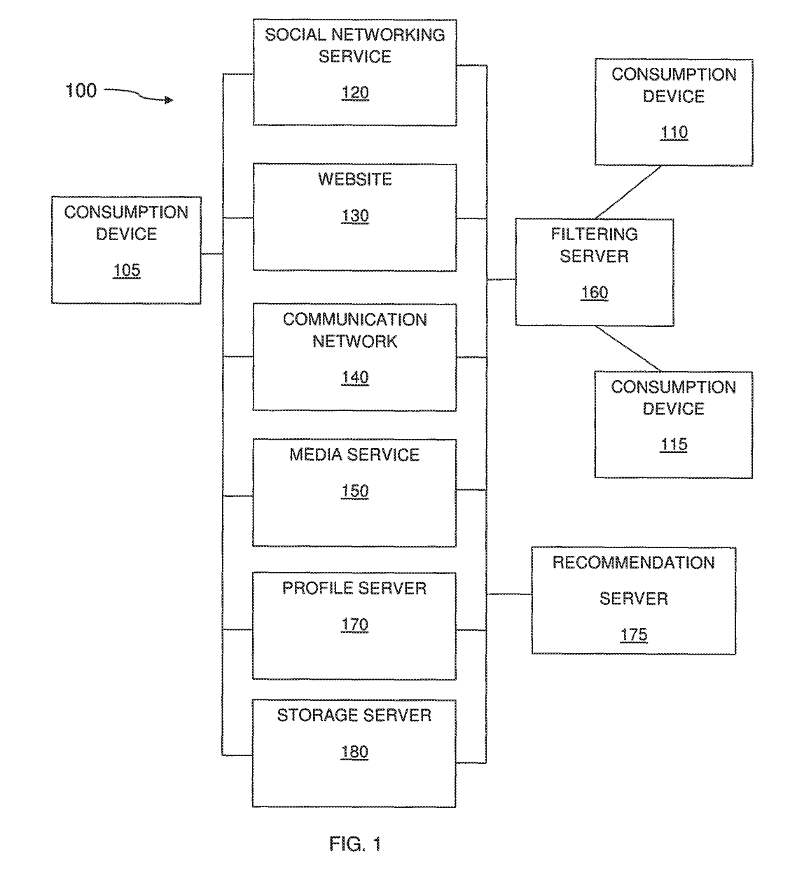

FIG. 1 is an exemplary embodiment of a system 100 in accordance with the present disclosure. Consumption device 105 represents a device such as a computer, set top box, tablet, television, phone, personal access device, gateway, and the like that is used to communicate an electronic communication to other devices such as consumption device 110 or consumption device 115.

The publishing of media assets between users operating consumption devices 105, 110, and 115 can take place through various social publishing services such as social network service 120. Examples of social networking services include, but are not limited to, FACEBOOK, GOOGLE+, MYSPACE, LINKEDIN, PINTREST, INSTAGRAM, TUMBLR and the like. The communication of media assets via social publishing services between users can also take place via a website 130 and/or a communication network 140 such as, and not limited to, a telephone connection, satellite, connection, cellular network, WI-Fl Digital Subscriber Line (DSL), Internet communication, and the like. Media service provider 150 include, but are not limited to, NETFLIX, M-GO, AMAZON CLOUD SERVICE, ITUNES, PANDORA, FLICKR and the like can also be used to communicate media assets between users who use devices such as consumption devices 105, 110, and 115.

Filtering server 160 can filter the delivery of media assets between consumption devices 105, 110, and 120. That is, media assets are communicated from a social publishing service are first communicated to filter server 160 in order to determine if such media assets should be made available to different consumption devices. Filter server 160 can be set up to determine if the media asset is of a particular type, comes from a specified social publishing service, is published by a specified party using such a social publishing service, and to whom the media asset is being communicated to. Such information can come from the social publishing services themselves, a profile server 170 that contains profile information of different users, from users themselves, and the like. Filter server 160 based on the determinations listed above can communicate media assets to a user, prevent the communication of media assets to a user, forward media assets to a user, block the forwarding of media assets to a user, filter media assets, provide media assets, change access privileges to media assets, and the like.

In an optional embodiment, the operation of filtering server 160 can be performed within a social publishing service such a social networking service 120, website 130, communication network 140, media service provider 150, and the like. In another optional embodiment, the operation of filtering server 160 can also be performed within a consumption device 105, 110, 115, and the like.

Profile server 170 contains user profile data that indicates a user's preferences including the type of media assets the user wants to receive, the social publishing services used, the specified parties a user is connected with through such social publishing services, media asset filtering data, and the like. Such data can come from sources such as a consumption device 105, 110, 115, social networking service 120, website 130, communication network 140, media service provider 150, filtering service 160, a user, other social publishing service, and the like.

Profile server 170 can be implemented to keep track of the preferences and the specific media assets that a user has consumed in the past. Specifically, when a user consumes a media asset at the point of consumption device 105, 110, 115 which can be delivered from a source such as a media service provider 150, the user can indicate their respective like or dislike for a media asset by indicating a rating for such an asset. Profile service 170 can also be implemented to keep track of how a user actually consumes a media asset where, for example, a media asset which is stopped before such a media asset is completely played back could have a lower rating than a media asset that is completely consumed by a user watching such an asset to the end of the presentation. Other methodologies can be used to develop a user profile in accordance with the illustrative principles, where such user profile information can be developed for multiple users who use consumption devices 105, 110, 115, and the like.

Recommendation server 175 is a server that is implemented to give recommendations based on the user profile information that can come from sources such as consumption devices 105, 110, 115, social networking service 120, website 130, communication network 140, media service provider 150, filtering server 160, user profile server 170, storage server 180, and the like. Specifically, the recommendations that recommendation server 175 provides are for media assets that would be of interest to a user where the recommendations are made in view of the user profile data of a that user. The implementation of recommendation server 175 can make use of analytics software which data mines user profile data from user profile information and data listing the various media assets that are available for consumption through as consumption devices 105, 110, 115, social networking service 120, website 130, communication network 140, media service provider 150, storage server 180, and the like. Recommendation server 175 can also give recommendations for two or more users, when prompted, where the recommendations would be of interest to the two or more users if such people were to consume the same content. For example, media service provider 150 can offer a party viewing mode where two or more users, who are connected in a manner as described herein, can request to watch the same media asset at the same time. Recommendation server 175 could then recommend one or more media assets that would be of interest to the two or more users where such media assets would be available from the media service provider 150 during the party viewing mode. Recommendations can also be delivered in other settings too where two or more users are interested in accessing media assets at different times, but such users still want to know what media assets would be of interest to such users. Other approaches can apply to when two or more users would want to receive recommendations for media assets in accordance with the illustrative principles presented.

Storage server 180 contains media assets that are communicated from sources such as a consumption device 105, 110, 115, social networking service 120, website 130, communication network 140, media service provider 150, filtering service 160, a user, other social publishing service, and the like. Storage server 180 can also operate a storage locker for media assets.

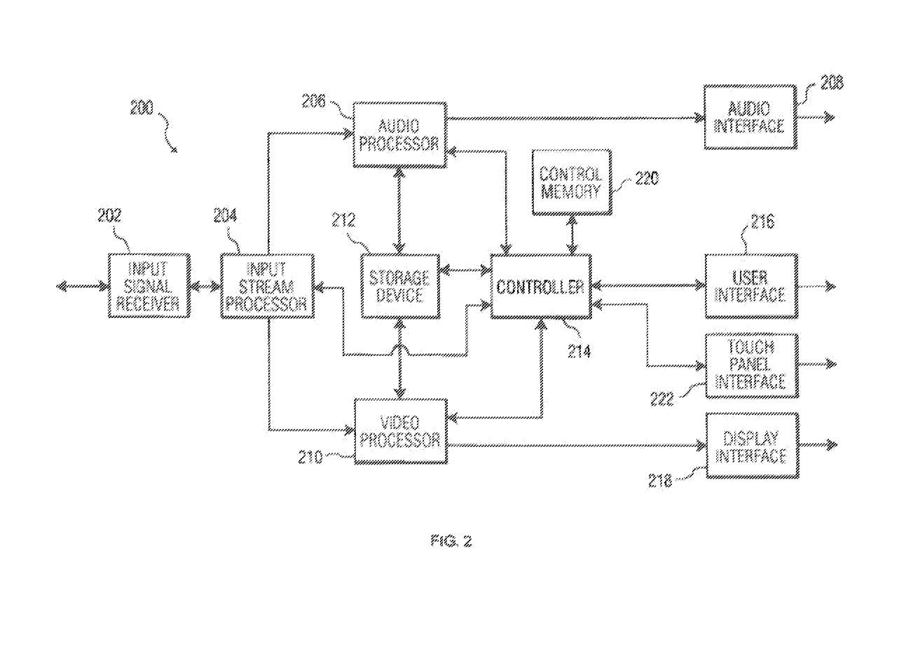

Turning now to FIG. 2, a block diagram of an embodiment of a consumption device 200 is shown. The device 200 shown can be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 can be one of several known receiver circuits used for receiving, demodulation, and decoding signals provided over one of the several possible networks including over the air, cable, satellite, Ethernet, fiber and phone line networks. The desired input signal can be selected and retrieved by the input signal receiver 202 based on user input provided through a control interface or touch panel interface 222. Touch panel interface 222 can include an interface for a touch screen device. Touch panel interface 222 can also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 can provide a digital signal to an audio output device or display device using a High-Definition Multimedia Interface (HDMI) cable or alternate audio interface such as via a Sony/Philips Digital Interconnect Format (SPDIF). The audio interface can also include amplifiers for driving one more sets of speakers. The audio processor 206 also performs any necessary conversion for the storage of the audio signals.

The video output from the input stream processor 204 is provided to a video processor 210. The video signal can be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 can be a hard disk drive, one or more large capacity integrated electronic memories, such as static RAM (SRAM), or dynamic RAM (DRAM), or can be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 can be an analog signal interface such as red-green-blue (RGB) or can be a digital interface such as HDMI. It is to be appreciated that the display interface 218 will generate the various screens for presenting the search results in a two dimensional form as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 can interface with a search engine for the searching of content and the creation and adjusting of the display of graphical objects representing such content which can be stored or to be delivered via storage server 180, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 can store instructions for controller 214. Control memory 220 can also store a database of elements, such as graphic elements containing content, various graphic elements used for generating a displayed user interface for display interface 218, and the like. Alternatively, the memory can store the graphic elements in identified or grouped memory locations and use an access or location table to identify the memory locations for the various portions of information related to the graphic elements. In addition, various graphic elements can be generated in response to computer instructions interpreted by controller 214 for output to display interface 218. Additional details related to the storage of the graphic elements will be described below. Further, the implementation of the control memory 220 can include several possible embodiments, such as a single memory device or, alternatively, more than one memory circuit communicatively connected or coupled together to form a shared or common memory. Still further, the memory can be included with other circuitry, such as portions of bus communications circuitry, in a larger circuit.

Optionally, controller 214 can be adapted to extract metadata from audio and video media by using audio processor 206 and video processor 210, respectively. That is, metadata that is contained in the video signal in the vertical blanking interval, auxiliary data fields associated with video, or in other areas in the video signal can be harvested by using the video processor 210 with controller 214 as to generate metadata that can be used for functions such as generating an electronic program guide, providing descriptive information about received video, supporting an auxiliary information service, and the like. Similarly, the audio processor 206 working with controller 214 can be adapted to recognize audio watermarks that can be in an audio signal. Such audio watermarks can then be used to perform some action such as the recognition of the audio signal identifying the source of an audio signal, or performing some other service. Furthermore, metadata to support the actions listed above can come from a network or other source.

Referring back to FIG. 1, profile server 170 can be implemented to keep track of a user's preferences including the type of media assets the user wants to receive, the social publishing services used, the specified parties a user is connected with through such social publishing services, where an example of such information for a user is shown in TABLE 1 in accordance with the presented principles.

TABLE 1

| | SOCIAL | | | | |
|---|---|---|---|---|---|
| SPECIFIED | PUBLISHING | PIC- | | | |
| PARTY | SERVICE | TURES | MESSAGES | AUDIO | VIDEO |
| FRIEND A | FACEBOOK | NO | YES | YES | YES |
| FRIEND A | TWITTER | NO | YES | NO | YES |
| FRIEND A | INSTAGRAM | YES | NO | NO | NO |
| FRIEND B | FACEBOOK | YES | NO | YES | YES |
| FRIEND B | TWITTER | NO | YES | NO | NO |
| FRIEND B | INSTAGRAM | NO | NO | NO | NO |
| FRIEND B | FLICKR | YES | NO | NO | NO |

The column for specified party represents the different people/entities that a user has a permissive relationship with. Social publishing service indicates a particular social publishing service that a user receives communications from in the form of media assets which are published from specified parties. The next four columns represent different types of media assets including pictures, messages, audio, and videos. The Yes or No indicate whether a user is supposed to receive a media asset type from a specified party which is communicated through a social publication service. Information that defines the specified party, media asset, media asset type, source of a published asset, social publishing service, and the like can come from commands that come from a social publishing service, metadata embedded within a media asset, metadata associated with a media asset, a separate stream of metadata, an XML commands, and the like. The described operations of permitting and preventing communications of media assets, as listed for TABLE 1 can be performed by consumption devices 105, 110, 115, social networking service 120, website 130, communications network 140, media service provider 150, filtering server 160, profile server 170, storage server 180, and the like, in accordance with the described principles.

Referring back to FIG. 1, recommendation server 175 can be implemented give media asset recommendations based on user profile information for a user or for a group of users. TABLE 2 provides an example of media assets recommendations for different users and groups of users in accordance with the presented principles.

TABLE 2

| USER(S) | MEDIA ASSET RECOMMENDATIONS |
|---|---|
| PRIMARY USER | PARANORMAL ACTIVITY, SAW |
| FRIEND A | PRETTY WOMAN, FRIED GREEN |
| | TOMATOES |
| FRIEND B | BULL DURHAM, TIN CUP, RAMBO III |
| PRIMARY USER AND | GHOST, LOST |
| FRIEND A | |
| PRIMARY USER AND | EXPENDIBLES, FRINGE, DOCTOR |
| FRIEND B | WHO |
| FRIEND A AND FRIEND B | LEAGUE OF THEIR OWN, |
| | THE CLIENT |
| PRIMARY USER, FRIEND | LOST, FRINGE, THE OTHERS |
| A, AND FRIEND B | |

The user column in TABLE 2 represents the different combinations of for which recommendations are being requested and media asset recommendations represent the specific commendations being made for a primary user and the respective friends who are also users. It is noted that groups of three or more users can also be implemented in accordance with the disclosed principles.

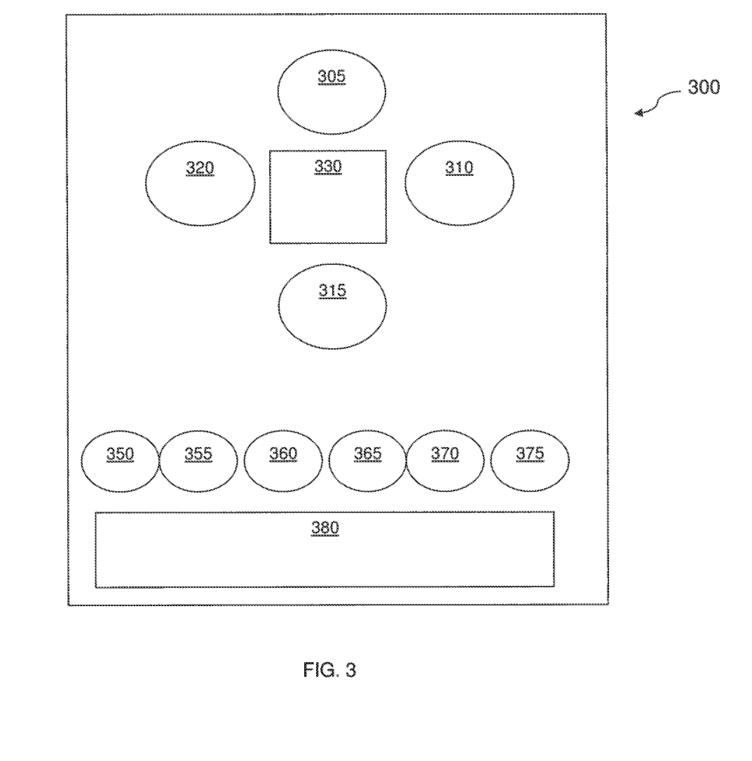

FIG. 3 is a representation of a user interface 300 that is used for generating recommendations in accordance with the presented principles. User interface 300 presents a number of zones 305, 310, 315, and 320 where a user can move any one of user representations 350, 355, 360, 365, 370, and 375 to these zones using an input device such as a mouse, touch input, keyboard, and other device capable of accepting user input. User representations 350, 355, 360, 365, 370, and 375 can be a picture of a user, an avatar of a user, text comporting to a user, a mixture of graphics and text of a user, and the like. Ideally, the user representations 350, 355, 360, 365, 370, and 375 each represent unique users with associated user profile information that can be accessed and stored in profile server 170. Recommendation zone 330 is interposed between zones 305, 310, 315, and 320 where instead of text being shown as media asset recommendations, a graphical element from a media asset such as a picture, video, poster art, and the like from the media asset is shown. Such graphical elements can come from recommendation server 175 directly, from a media service provider 150, and the like. Preferably, a short video clip of a recommended media asset is shown in recommendation zone 330 where multiple videos of corresponding recommended media assets can be cycled through and shown in recommendation zone 330 in response to user input. Textual results of recommended media assets can also be shown in results zone 380, as well. The recommendations shown in recommendation zone 330 and results area 380 will depend on which user representations 350, 355, 360, 365, 370, and 375 are placed within zones 305, 310, 315, and 320.

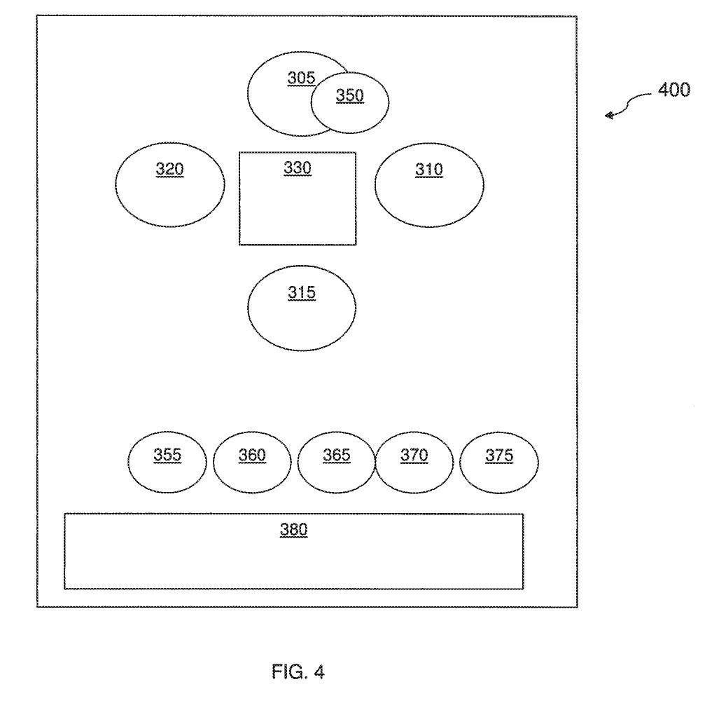

FIG. 4 is a representation of a user interface 400 that is used for generating recommendations in accordance with the presented principles. In the provided example, a user representation 350 comporting to a first user is placed within zone 305. In response to this action, recommendation server 175 can present data in recommendation zone 330 and in results 380 that comports to recommendations for the first user.

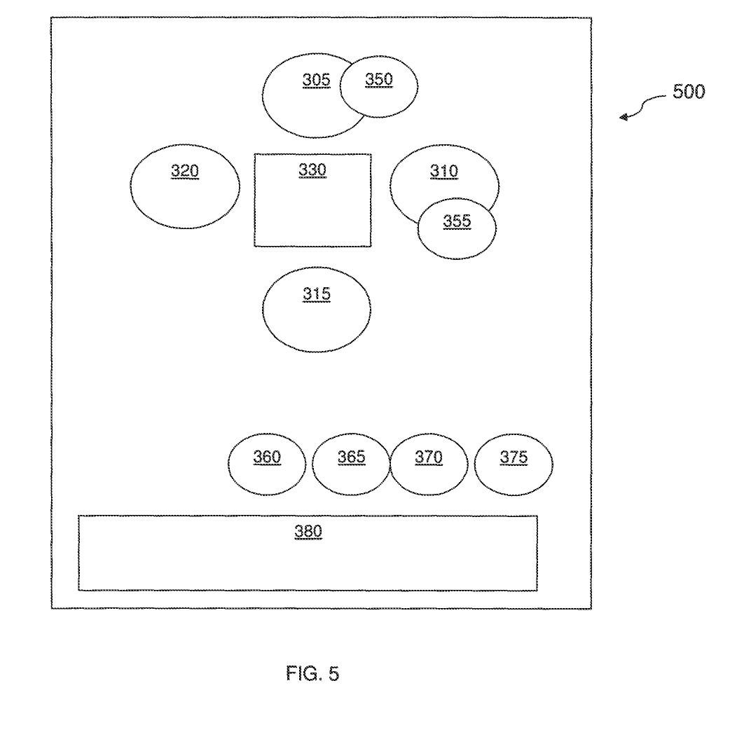

FIG. 5 is a representation of a user interface 500 that is used for generating recommendations in accordance with the presented principles. In the provided example, a user representation 350 comporting to a first user is placed within zone 350 while a user representation 355 for a second user is placed within a second zone 310. The outcome of such an action causes recommendation server 175 to generated recommendations to be presented in recommendation zone 330 and in results 380 that are recommendations for the first and second user.

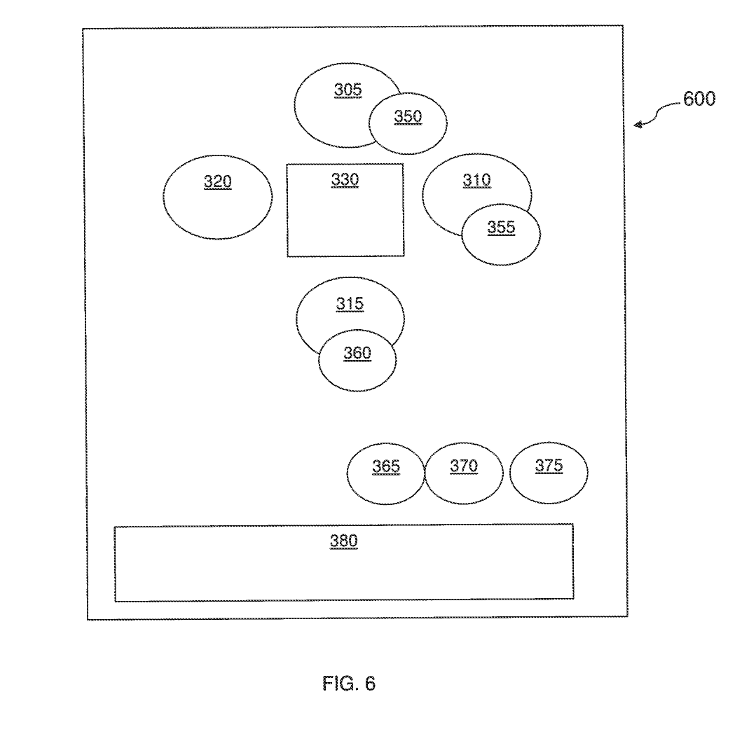

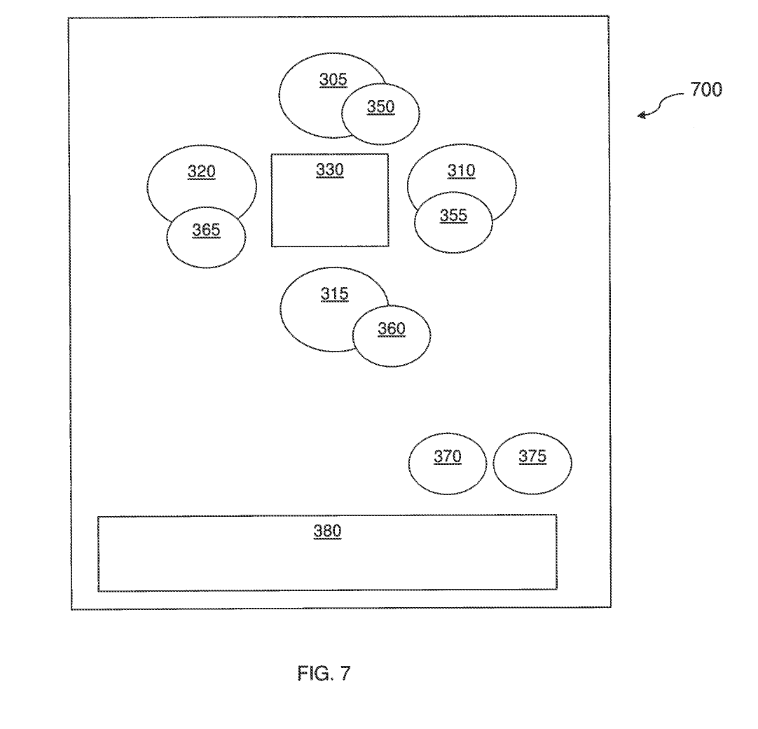

FIG. 6 presents a user interface 600 that has media asset recommendations being generated for a combination of three users. Specifically, user representations 350 of a first user, 355 of a second user, and 360 of third user are placed within zones 305, 310, and 315, respectively. The recommendations that are shown in recommendation zone 330 and in results 380 comport to recommendations for these three users. FIG. 7 presents a user interface 700 that has media asset recommendations being generated for a combination for four users as user representation 365 for a fourth user is being placed within zone 320.

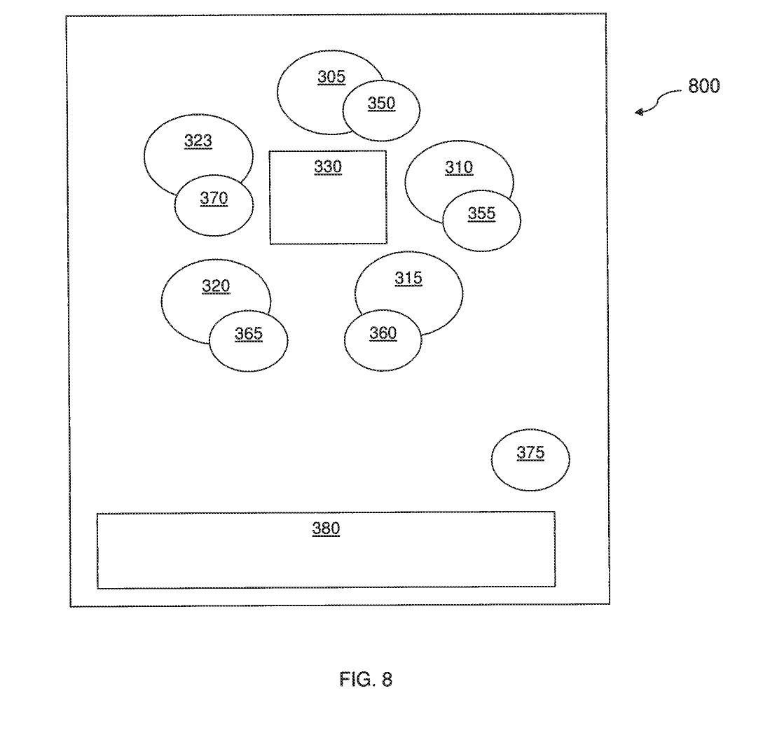

FIG. 8 presents a user interface 800 that has media asset recommendations being generated for a number of users. In this example, zones 305, 310, 315, and 320 previously existed as shown in FIGS. 3-7. When a user representation 370 comporting to a fifth user is placed by the preexisting zones, a new zone 323 is displayed for which user representation 370 can be placed. The results of the placement of user representation 370 within new zone 323 causes the generation of media asset recommendations for five users, where each user comports to user representations 350, 355, 360, 365, and 375 respectively. Note, although new zones can be added as needed, there can be a predetermined limit to the number of zones that can be added where such a limit is decided according to aesthetic reasons. Other versions of the disclosed user interfaces can be implemented in accordance with the presented principles.

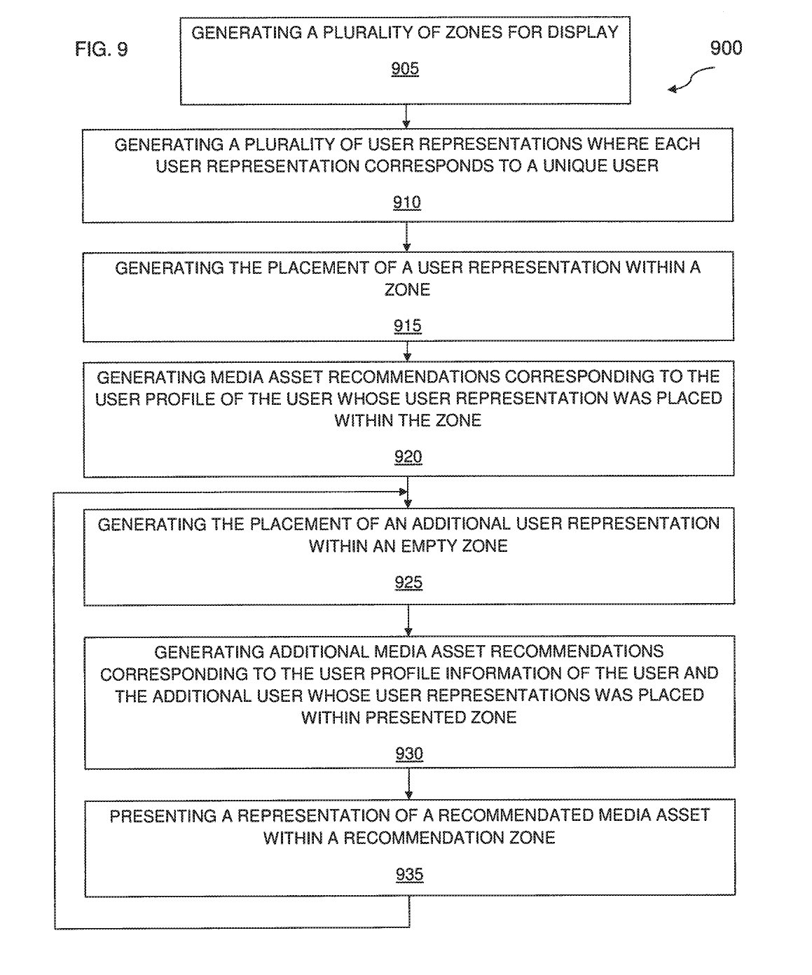

FIG. 9 is a representation of flow chart for a method 900 that is used for generating recommendations in accordance with the presented principles. The described steps can be implemented using a device 200, consumption devices 105, 110, 115, social networking service 120, website 130, communications network 140, media service provider 150, filtering server 160, profile server 170, recommendation server 175, storage server 180, and the like.

In step 905, a user interface is generated that displays a plurality of zones 305, 310, 315, and 320. Such zones, as shown in FIGS. 3-8, can be any shape. In step 910, a plurality of user representations 350, 355, 360, 365, 370, and 375 are shown in a user interface where each user representation corresponds to a unique user. Such user representations, as shown in FIGS. 3-8, can be of any shape.

In step 915, in response to user input by the manipulation of a user interface, a user representation such as 350, 355, 360, 370, and 375 is placed within a zone such as 305, 310, 315, and 320. The result of the placement of a selected user representation within a selected zone is that user profile server 170 presents user profile data to recommendation server 175, where the data corresponds to the user to whom such a representation corresponds. Recommendation server 175, in step 920, then performs a lookup or other processing technique and ends up recommending one or more media assets that would be of interest to the user using the user profile data. The media asset recommendations can be presented in a recommendation zone 330 as videos, pictures, and poster art and as text in results area 380.

In step 925, in response to user input by the manipulation of a user interface, an additional user representation such as 350, 355, 360, 370, and 375 is placed within an empty zone such as 305, 310, 315, and 320 and is displayed. The additional user representation comports to a second user. In step 930, the user profile data comporting to the first user and second user can be accessed from profile server 170 and recommendation server 175 can be accessed using the user profile data to generate additional media asset recommendations for the two users. The additional media asset recommendations can then be presented in recommendation zone 330 and in results area 380 during step 935. Note, steps 925 930, 935 can be repeated to accommodate more than two users and corresponding media asset recommendations.

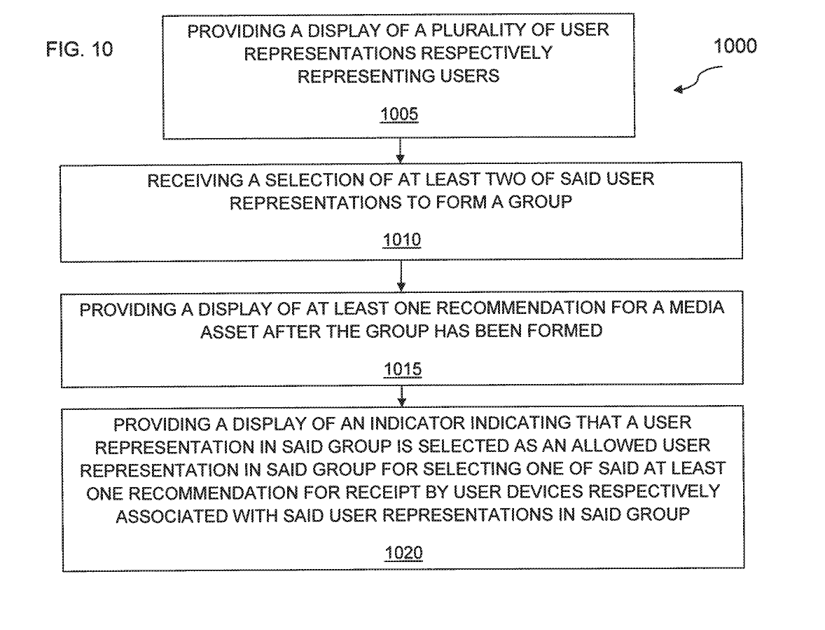

FIG. 10 illustrates an exemplary process flow 1000 for enabling automatic selection of a user representation in a group to select a recommendation displayed in the result zone 380 for receipt by user devices associated with the user representations in the group. For simplicity, the combination of the social networking service 120, media service 150, profile server 170, recommendation server 175, and storage server 180 is called a server in the description of FIG. 10. The combination of elements may be implemented with one or more processor or computer with internal or external memory and/or storage.

Briefly, when the controller 214 of a user device, such as one of the consumption devices 105, 110, 115, detects that a user moves at least two user representations 350, 355, 360, 365, 370, 375 (FIG. 3) to the zones 305, 310, 315, 320, 323, or other zones if the number of the moved user representations is more than five in the embodiment shown in FIG. 8, the controller 214 stores the identifications of the moved user representations in the storage device 212 as a group and informs the server of the group. The information sent to the server may include a group name and the associated user representations.

The process 1000 starts at step 1005, in which the controller 214 of the user device is operative to provide a display of a plurality of user representations, such as the user representations 350, 355, 360, 365, 370, and 375 shown in FIG. 3, when the user representation has logged onto the server. The controller 214 enables a display by providing display information to the video processor 210 and the processed signal produced by the video processor 210 is displayed in a display device (not shown) through the display interface 218. In effect, the controller 214 enables the video processor 210 to produce display signals to be displayed by the display device responding to the display information sent by the controller 214.

At step 1010, the controller 214 of the user device is operative to receive a user selection of at least two of said user representations to form a group. For example, as shown in FIG. 8, user representations 350, 355, 360, 365, and 370 are selected to form a group by the user placing those user representations to the zones 305, 310, 315, 320, 323, as illustrated in FIG. 8.

At step 1015, the controller 214 of the user device is operative to provide a display of at least one recommendation for a media asset. As discussed earlier, when a group is formed, the server can access user file data comporting to users corresponding to user representations in the group and generate the at least one media asset recommendation for the group. It should be noted that any other user device associated with a user representation in the group, when logged onto the server, should be operative to receive the at least one recommendation and is capable of displaying the at least one recommendation in a similar manner. Any other user device can also receive group information from the server, so that the corresponding user is aware of which group the user is in. In one embodiment, a user representation can be in more than one group. In this embodiment, the corresponding user must select one group to be active at a given time in his/her user device.

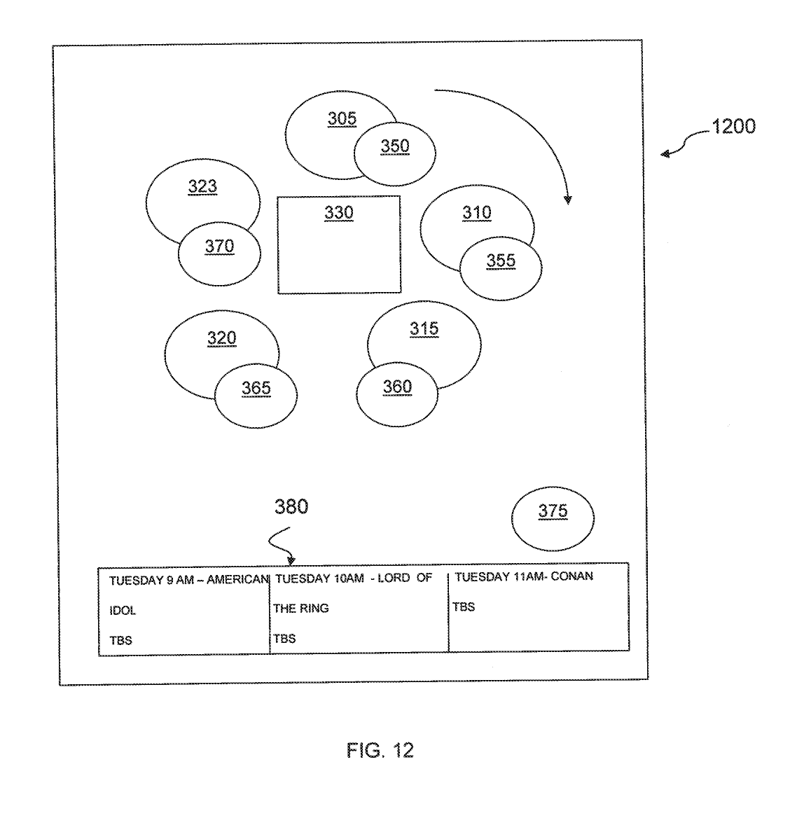

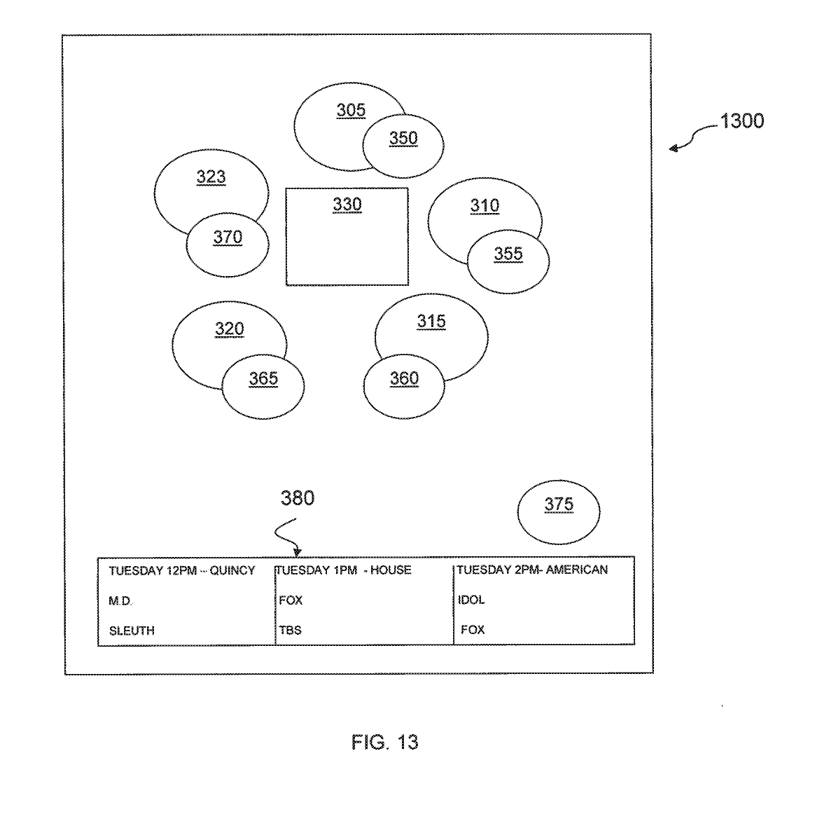

In one embodiment, not all recommendations in said at least one recommendation is displayed on the result zone 380. Rather, only a first set of recommendations in the at least one recommendation with start times falling within a particular time interval, for example, from 9:00 am to 12:00 pm are displayed in the result zone 390, as shown in FIG. 12, as to form a version of an electronic program guide. As will be described later, a user is allowed to change the display interval, for example, from 9:00 am-12:00 pm to 12:00am-3:00pm as shown in FIG. 13, replacing the first set in the display in the result zone 380 with a second set in the at least one recommendation having start times falling within 12:00am-3:00pm. The first set in display can be replaced by a third set in the at least one recommendation having start time within an earlier time interval in the result zone 380 responding to a user signal.

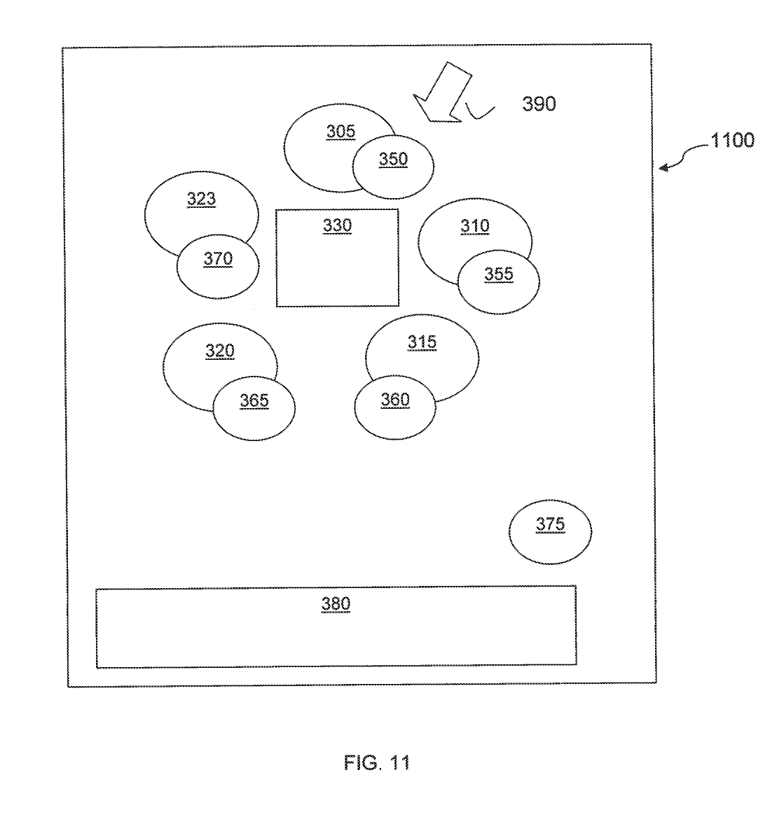

At step 1020, the controller 214 of the user device is operative to provide a display of an indicator indicating that a user representation in the group is automatically selected as an allowed user representation in the group for selecting one of the at least one recommendation for receipt by user devices respectively associated with the user representations in the group. An example of an indicator is an arrow 390 pointing to the selected user representation as shown in FIG. 11. The indicator may be just displaying the selected user representation in a different color than others in the group in one embodiment. As long as an indication allows a user to distinguish the selected allowed user representation from others, the indication is a good indicator. In one embodiment, each user may be allowed by the controller 214 to customize his/her own indicator.

In one embodiment, the server automatically selects the user representation that forms the group as the first allowed user representation in the group for selecting one of the at least one recommendation for receipt by user devices respectively associated with the user representations in the group. When a user representation alters the membership of the group, that user representation may also be selected as the first allowed user representation in the new group. The server sends the selection to user devices associated with user representations in the group that are currently logged onto the server, so that the same indication can be displayed on those user devices.

In another embodiment, the server can randomly select one of the user representations in the group as the allowed user representation for the group. The selected user representation preferably is currently logged onto the server.

In yet another embodiment, the process flow 1000 may include a step of after the selected allowed user presentation in the group has made a selection, i.e., selecting one of the at least one recommendation for playback by devices associated with user representations in the group, the controller 214 of the user device is operative to provide a display of the indicator indicating that another user representation in the group is selected as the allowed user representation. Once the server has received the selection of one of the at least one recommendation, the server selects another user representation in the group as the allowed user representation in the group and informs user devices associated with user representations in the group that are currently logged onto the server, so that the user devices can display the indicator indicating that another user in the group has been selected as the allowed user representation in the group. When a member user representation is newly logged onto the server, the server automatically sends the user device corresponding to the newly login user representation the group information and the associated selected allowed user representation for each group of which the newly login user representation is a member.

In one embodiment, for fairness, once a user representation in the group has been selected, the server should not select that user representation again as the allowed user representation until all other user representations in the group have been selected once. In effect, in each round, each user representation is selected once as the allowed user representation. This ensures that each user representation has about the same chance to be selected. The selection algorithm can be round robin or random. If the random algorithm is used, the server should check the output from a random generator to ensure fairness. For example, if the user representations 350, 355, and 365 have been selected and in the process of selecting another user presentation, the output from the random generator is not one of the user representations 360 and 370, the server should run the random generator again until one of the user representations 360 and 370 is generated by the random generator.

As shown in the exemplary interface 1200 in FIG. 12, in the result zone 380, the user interface 1200 only displays those recommendations (the first set) in the at least one recommendation having start times falling within a particular time interval (9 am-12 pm as an example). In this embodiment, a user may advance (cause to go forward) or retreat (cause to go backward) the particular time interval by, for example, moving a user representing in one direction forcing other user representations to move in the same direction as well. For example, as shown in

FIG. 12, if a user moves user representation 350 in the clockwise direction, the time interval advances from 9am-12pm to 12pm-3pm, as shown in FIG. 13. Similarly, if a user moves the user representation 350 in FIG. 13 in the counter clockwise direction, the time interval changes back to 9am-12pm. In one embodiment, a user can move a finger in the peripheral area of an input device such as a tablet in one direction or the other without moving the user representations to achieve similar effects.

Although as shown in FIG. 12, the group is displayed in a circular manner, the controller 214 may arrange user configurations in a group as a list and moving a finger along one direction advances the time interval and the other direction along the list retreats the time interval.

In one embodiment, the server distributes the cost of a selection of a recommendation for the group to all members of the group when such a selection was made. If a new user representation joins the group after a selection has been made, the server inquires the new user representation if the new user representation wants to receive the selection for playback. If the answer is yes, the server sends the content of the selection to the user device associated with the new user representation when the playback of the selection has arrived and charges the new user representation equal share. If the answer is no, the user device associated with the new user representation will not receive the selection and is not charged.

In yet another embodiment, if a user representation is a member of the group when a selection is made and later drops out of the group before the start time of the selected recommendation has arrived, the server may charge or not charge the user representation according to a published set of rules available to all users.

In one embodiment, the user device, such as a smart television or a set-top box, may be shared by different users having different local user accounts but the users share just one server account. Thus, the server maintains just one user profile for this user device. In this embodiment, a local user profile for each user is locally stored. When a user logged onto the server, the controller 214 of the user device displays the user representations, similar to step 1005, and receives a selection of at least two user representations to form a group, similar to step 1010. However, the server is not informed of the group. Rather the controller 214 creates a new profile data comporting to the local profiles of member user representations in the group and requests the server to use this new profile data for the single user representation. In response, the server sends at least one recommendation to the user device according to the new profile data. Every time group membership is changed, a new profile data is created by the controller 214 and sent to the server. The controller 214 of the user device provides a display of the at least one recommendation, similar to step 1015. The controller 214 of the user device in this embodiment is also responsible for selecting a user representation as an allowed user representation in the group using algorithms described above and for providing a display of an indicator indicating that a user representation in the group is selected as an allowed user representation, similar to step 1020. The controller 214 also performs similar functions in different embodiments described previously for the multi-user device environment where each user representation is associated with a different user device.

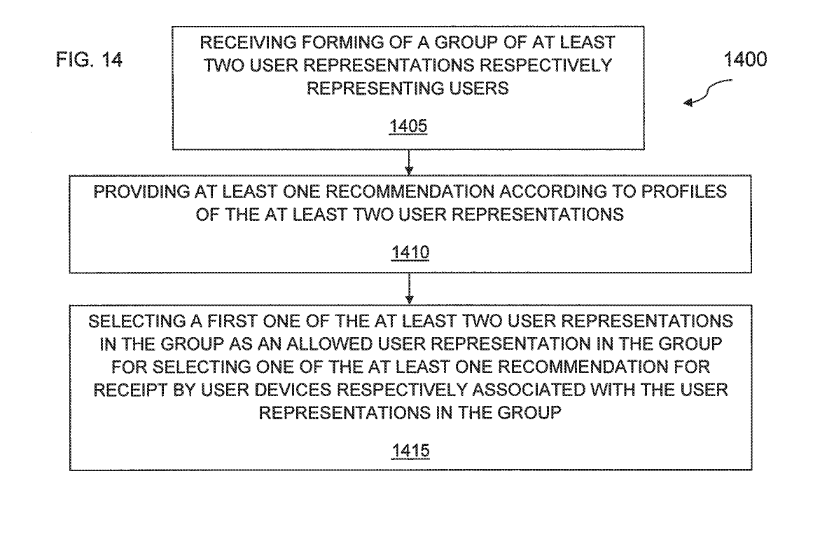

FIG. 14 illustrates an exemplary process flow 1400 in the server for automatic selection of a user representation in a group for selecting one of the at least one recommendation for receipt by user devices respectively associated with the user representations in the group. The process flow may be executed by processor or processors in the server.

At step 1405, the server receives forming of a group of at least two user representations respectively representing users from a user device associated with a user representation.

At step 1410, the server provides at least one recommendation according to profiles of the at least two user representations in the group, as described previously.

At step 1415, the server selects a first one of the at least two user representations in the group as an allowed user representation in the group for selecting one of the at least one recommendation for receipt by user devices respectively associated with the user representations in the group. The server should reject selections by user representations other than the allowed user representation in the group.

In one embodiment, the server automatically selects the user representation that forms the group as the first allowed user representation in the group for selecting one of the at least one recommendation for receipt by user devices respectively associated with the user representations in the group. When a user representation alters the membership of the group, that user representation may also be selected as the first allowed user representation in the new group.

In another embodiment, the server should send the content of the selection to user devices associated with user representations in the group when the start time of the selection has arrived. Preferably, those user devices associated with the user representations in the group should have logged onto the server.

In yet another embodiment, the server can randomly select one of the user representations in the group as the allowed user representation for the group. The selected user representation preferably is currently logged onto the server.

In yet another embodiment, once the server has received the selection of one of the at least one recommendation, the server selects another user representation in the group as the allowed user representation in the group and informs user devices associated with user representations in the group that are currently logged onto the server, so that the user devices can be operative to display the indicator indicating that another user in the group has been selected as the allowed user representation in the group. When a member user representation is newly logged onto the server, the server automatically sends the user device corresponding to the newly login user representation the group information and the associated selected allowed user representation for each group of which the newly login user representation is a member.

In one embodiment and as discussed above, for fairness, once a user representation in the group has been selected, the server should not select that user representation again as the allowed user representation until all other user representations in the group have been selected once. In effect, in each round, each user representation is selected once as the allowed user representation. This ensures that each user representation has about the same chance to be selected. The selection algorithm can be round robin or random. If the random algorithm is used, the server should check the output from a random generator to ensure fairness. For example, if the user representations 350, 355, and 365 have been selected and in the process of selecting another user presentation, the output from the random generator is not one of the user representations 360 and 370, the server should run the random generator again until one of the user representations 360 and 370 is generated by the random generator.

In one embodiment, the server distributes the cost of a selection of a recommendation for the group to all members of the group when such a selection was made. If a new user representation joins the group after a selection has been made, the server inquires the new user representation if the new user representation wants to receive the selection for playback. If the answer is yes, the server sends the content of the selection to the user device associated with the new user representation when the playback of the selection has arrived and charges the new user representation equal share. If the answer is no, the user device associated with the new user representation will not receive the selection and is not charged.

In yet another embodiment, if a user representation is a member of the group when a selection is made and later drops out of the group before the start time of the selected recommendation has arrived, the server may charge or not charge the user representation according to a published set of rules available to all users.

However, it should be understood that the elements shown in the figures can be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. It is noted that modifications and variations can be made by persons skilled in the art in light of the above teachings.

1. A method for selecting recommendations comprising:
providing a display of a plurality of user representations respectively representing users;
receiving a selection of at least two of said user representations to form a group in response to a user input;
providing a display of at least one recommendation for a media asset after said group has been formed; and
providing a display of an indicator indicating that a user representation in said group is selected as an allowed user representation in said group for selecting one of said at least one recommendation for receipt by user devices respectively associated with said user representations in said group.

2. The method of claim 1, wherein said at least one recommendation is available for display in said user devices associated with said user representations in said group.

3. The method of claim 2, further comprising a step of after said selected allowed user representation in said group has made a selection, providing a display of said indicator indicating another user representation in said group is selected as said allowed user representation.

4. The method of claim 3, wherein said selected allowable user representation is prevented from being selected again until all other user representations in said group have been selected as said allowed user representation.

5. The method of claim 4, wherein a user representation is selected as said allowed user representation in a random manner.

6. The method of claim 4, wherein a user representation is selected as said allowed user representation in a round robin manner.

7. The method of claim 2, wherein a first set of said at least one recommendation falling in a first time interval are displayed according to start time, wherein start times of said first set are within said first time interval.

8. The method of claim 7, further comprising a step of providing a display of said user representations in said group in a circular manner.

9. The method of claim 8, further comprising steps of:
replacing the first set with a second set in said at least one recommendation in display responsive to detecting rotation movement around said group in one direction, wherein a second time interval is later than said first time interval and said second set in said at least one recommendation having start times within said second time interval; and
replacing the first set with a third set in said at least one recommendation in display responsive to detecting rotation movement around said group in the other direction, wherein a third time interval is earlier than said first time interval and said third set in said at least one recommendation having start time within said third time interval.

10. The method of claim 2, wherein said selected recommendation is placed in a queue by a server and said server delivers said selected recommendation when a start time of said selected one of said at least one selected recommendation has arrived.

11. A user device for selecting recommendations comprising:
a video processor interfacing with a display device; and
a controller enabling said video processor to produce display signals,
wherein said controller is operative to enable display of a plurality of user representations respectively representing users, selection of at least two of said user representations to form a group, display of at least one recommendation for a media asset after said group has been formed; and display of an indicator indicating that a user representation in said group is selected as an allowed user representation in said group for selecting one of said at least one recommendation for receipt by user devices respectively associated with said user representations in said group.

12. The user device of claim 11, wherein after said selected allowed user representation in said group has made a selection, said controller is operative to enable display of said indicator indicating another user representation in said group is selected as said allowed user representation.

13. The user device of claim 12, wherein said selected allowable user representation is prevented from being selected again until all other user representations in said group have been selected as said allowed user representation.

14. The user device of claim 12, wherein said controller is operative to enable display of a first set of said at least one recommendation falling in a first time interval according to start time wherein start times of said first set are within said first time interval.

15. The user device of claim 14, wherein said controller is operative to enable display of said user representations in said group in a circular manner.

16. The user device of claim 15, wherein said controller is operative to replace the first set with a second set in said at least one recommendation in display responsive to detecting rotation movement around said group in one direction, wherein a second time interval is later than said first time interval and said second set in said at least one recommendation having start times within said second time interval; and replaces the first set with a third set in said at least one recommendation in display responsive to detecting rotation movement around said group in the other direction, wherein a third time interval is earlier than said first time interval and said third set in said at least one recommendation having start time within said third time interval.

17. (canceled)

18. (canceled)

19. (canceled)

20. (canceled)

21. (canceled)

22. (Cancelled)

23. A method for providing recommendations comprising:
receiving forming of a group of at least two user representations respectively representing users;
providing at least one recommendation according to profiles of said at least two user representations; and
selecting a first one of said at least two user representations in said group as an allowed user representation in said group for selecting one of said at least one recommendation for receipt by user devices respectively associated with said user representations in said group.

24. The method of claim 23, further comprising a step of after said selected allowed user representation in said group has made a selection, selecting another user representation in said group as said allowed user representation.

25. The method of claim 24, wherein said selected allowable user representation is prevented from being selected again until all other user representations in said group have been selected as said allowed user representation.

26. The method of claim 25, wherein a user representation is selected as said allowed user representation in a random manner.

27. The method of claim 25, wherein a user representation is selected as said allowed user representation in a round robin manner.

28. The method of claim 23, further comprising a step of sending content of said selected one of said at least one recommendation to user devices respectively associated with said user representations in said group.
